(19) United States
(12) Patent Application Publication
(10) Pub. No.: US 2025/0275011 A1
(43) Pub. Date: Aug. 28, 2025

(54) WIRELESS COMMUNICATION METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/858,006

(22) PCT Filed: Apr. 24, 2022
(86) PCT No.: PCT/CN2022/088810

§ 371 Date: Oct. 18, 2024

(51) Int. Cl. H04W 76/28; H04W 52/02

(52) U.S. Cl. CPC H04W 76/28; H04W 52/02

(57) ABSTRACT

Provided in the embodiments of the present disclosure is a wireless communication method, the method is performed by a terminal, and the method includes: waking up a second type transceiver through a first type transceiver in response to the first type transceiver receiving a wakeup signal; wherein the second type transceiver comprises at least one of: a first transceiver, configured to perform data monitoring based on a discontinuous reception (DRX) parameter of a first DRX group; or a second transceiver, configured to perform data monitoring based on a DRX parameter of a second DRX group.

### CROSS-REFERENCE TO RELATED APPLICATION

The application is a U.S. National Stage of International Application No. PCT/CN2022/088810 filed on Apr. 24, 2022, the entire content of which is incorporated herein by reference.

### TECHNICAL FIELD

The present disclosure relates to, but is not limited to, the technical field of wireless communication, and in particular, to a wireless communication method and apparatus, a communication device and a storage medium.

### BACKGROUND

In wireless communication technology, in order to save power, a wakeup signal (WUS) is introduced for the connection state of radio resource control (RRC). Aiming at RRC idle state, a power-saving signal, namely a paging early indication (PEI), is introduced. In any scenario, the terminal needs to detect the wakeup signal or the power-saving signal through a radio frequency (RF) module.

### SUMMARY

Embodiments of the present disclosure disclose a wireless communication method and apparatus, a communication device and a storage medium.

According to a first aspect of the embodiments of the present disclosure, there is provided a wireless communication method, where the method is performed by a terminal, and the method includes:
waking up a second type transceiver through a first type transceiver in response to the first type transceiver receiving a wakeup signal;
where the second type transceiver includes at least one of:
a first transceiver, configured to perform data monitoring based on a discontinuous reception (DRX) parameter of a first DRX group; and
a second transceiver, configured to perform data monitoring based on a DRX parameter of a second DRX group.

According to a second aspect of the embodiments of the present disclosure, there is provided a wireless communication method, where the method is performed by an access network device, and the method includes:
sending capability information to a terminal;
where, the capability information is configured to indicate whether a first type transceiver of the terminal is supported or not supported to wake up a second type transceiver of the terminal after the first type transceiver receives a wakeup signal; and where the second type transceiver includes at least one of:
a first transceiver, configured to perform data monitoring based on a discontinuous reception (DRX) parameter of a first DRX group; and
a second transceiver, configured to perform data monitoring based on a DRX parameter of a second DRX group.

According to a third aspect of the embodiments of the present disclosure, there is provided a wireless communication apparatus, where the apparatus includes:
a wake-up module, configured to wake up a second type transceiver through a first type transceiver in response to the first type transceiver receiving a wakeup signal;
where the second type transceiver includes at least one of:
a first transceiver, configured to perform data monitoring based on a discontinuous reception (DRX) parameter of a first DRX group; and
a second transceiver, configured to perform data monitoring based on a DRX parameter of a second DRX group.

According to a fourth aspect of the embodiments of the present disclosure, there is provided a wireless communication apparatus, where the apparatus includes:
a sending module, configured to send capability information to a terminal;
where, the capability information is configured to indicate whether a first type transceiver of the terminal is supported or not supported to wake up a second type transceiver of the terminal after the first type transceiver receives a wakeup signal; and where the second type transceiver includes at least one of:
a first transceiver, configured to perform data monitoring based on a discontinuous reception (DRX) parameter of a first DRX group; and
a second transceiver, configured to perform data monitoring based on a DRX parameter of a second DRX group.

According to a fifth aspect of the embodiments of the present disclosure, there is provided a communication device, where the communication device includes:
a processor;
a memory, configured to store executable instructions of the processor;
where the processor is configured to implement the method according to any embodiment of the present disclosure when the executable instructions are executed.

According to a sixth aspect of the embodiments of the present disclosure, there is provided a computer storage medium storing a computer-executable program which, when executed by a processor, implements the method described in any embodiment of the present disclosure.

### BRIEF DESCRIPTION OF THE DRAWINGS

FIG. 1 is a schematic structural diagram of a wireless communication system according to an exemplary embodiment.

FIG. 2 is a schematic flowchart of a wireless communication method according to an exemplary embodiment.

FIG. 3 is a schematic flowchart of a wireless communication method according to an exemplary embodiment.

FIG. 4 is a schematic flowchart of a wireless communication method according to an exemplary embodiment.

FIG. 5 is a schematic flowchart of a wireless communication method according to an exemplary embodiment.

FIG. 6 is a schematic flowchart of a wireless communication method according to an exemplary embodiment.

FIG. 7 is a schematic flowchart of a wireless communication method according to an exemplary embodiment.

FIG. 8 is a schematic flowchart of a wireless communication method according to an exemplary embodiment.

FIG. 9 is a schematic flowchart of a wireless communication method according to an exemplary embodiment.

FIG. 10 is a schematic flowchart of a wireless communication method according to an exemplary embodiment.

FIG. 11 is a schematic diagram of a wireless communication apparatus according to an exemplary embodiment.

FIG. 12 is a schematic diagram of a wireless communication apparatus according to an exemplary embodiment.

FIG. 13 is a schematic structural diagram of a terminal according to an exemplary embodiment.

FIG. 14 is a block diagram of abase station according to an exemplary embodiment.

### DETAILED DESCRIPTION

Exemplary embodiments will be described in detail herein, examples of which are represented in the accompanying drawings. When the following description relates to the accompanying drawings, the same numerals in different drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with the appended claims and some aspects of the embodiments of the present disclosure.

Terms used in the embodiments of the present disclosure are used solely for the purpose of describing certain embodiments and are not intended to limit the embodiments of the present disclosure. The singular forms of “a/an”, “one” and “the” used in the appended claims and the embodiments of the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

For the purpose of conciseness and better understanding, the term “greater than” or “less than” is used herein to represent a size relationship. However, for those skilled in the art, it can be understood that the term “greater than” also covers the meaning of “greater than or equal to” and the term “less than” also covers the meaning of “less than or equal to”.

In the related art, a separate transceiver (i.e., a low power wake-up receiver) is introduced to receive a wakeup signal or a power-saving signal. After introducing the separate transceiver, how the terminal works is a problem that needs to be considered.

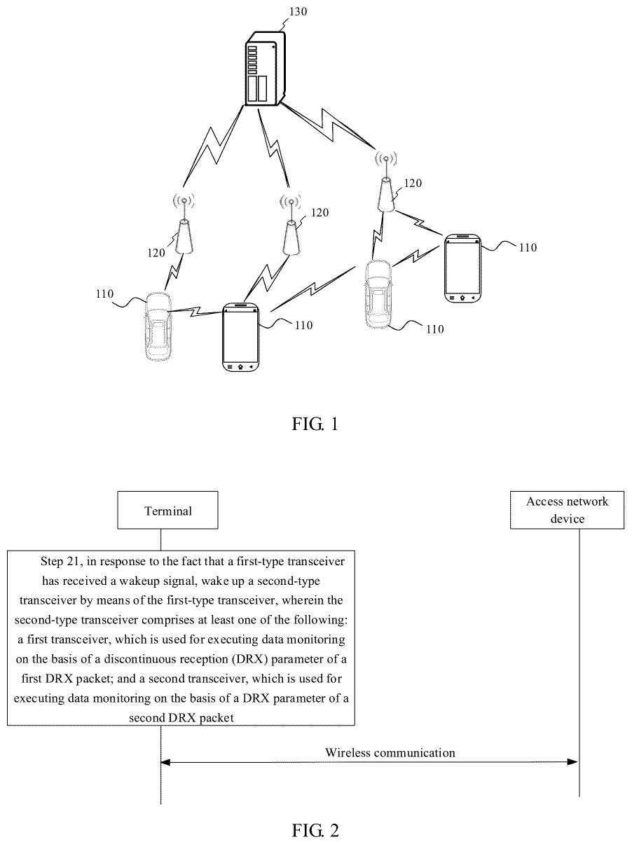

Referring to FIG. 1, a schematic structural diagram of a wireless communication system provided by an embodiment of the present disclosure is illustrated. As shown in FIG. 1, the wireless communication system is a communication system based on mobile communication technology, and the wireless communication system may include: several user equipments 110 and several base stations 120.

The user equipment 110 may refer to a device that provides voice and/or data connectivity to a user. The user equipment 110 may communicate with one or more core networks via a radio access network (RAN). The user equipment 110 may be an Internet of Things (IoT) user equipment, such as a sensor device, a mobile phone, and a computer with an IoT user equipment, for example, it may be a fixed, portable, pocket-sized, handheld, computer-built-in, or vehicle-mounted apparatus, e.g., a station (STA), a subscriber unit, a subscriber station, a mobile station, a mobile, a remote station, an access point, a remote user equipment (remote terminal), an access user equipment (access terminal), a user terminal, a user agent, a user device or a user equipment. Alternatively, the user equipment 110 may be a device of an unmanned aerial vehicle. Alternatively, the user equipment 110 may be a vehicle-mounted device, for example, it may be a trip computer with a wireless communication function, or a wireless user equipment externally connected to a trip computer. Alternatively, the user equipment 110 may be a roadside device, for example, a street lamp, a signal lamp, or other roadside device with a wireless communication function.

The base station 120 may be a network side device in a wireless communication system. The wireless communication system may be the 4th generation mobile communication technology (4G) system, also known as a long term evolution (LTE) system; or, the wireless communication system may be a 5G system, also known as a new air interface system or a 5G NR system. Alternatively, the wireless communication system may be a next generation system of the 5G system. The access network in the 5G system may be referred to as a new generation-radio access network (NG-RAN).

The base station 120 may be an evolved base station (eNB) used in a 4G system. Alternatively, the base station 120 may also be a base station (gNB) using a centralized and distributed architecture in a 5G system. When the base station 120 uses the centralized and distributed architecture, it usually includes a central unit (CU) and at least two distributed units (DUs). The central unit is provided with protocol stacks of a packet data convergence protocol (PDCP) layer, a radio link layer control protocol (Radio Link Control, RLC) layer, and a media access control (MAC) layer; and the distributed unit is provided with a protocol stack of a physical (PHY) layer. The specific implementation manner of the base station 120 is not limited by the embodiments of the present disclosure.

A wireless connection may be established between the base station 120 and the user equipment 110 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

In some embodiments, an End to End (E2E) connection may also be established between the user equipments 110, for example, a vehicle to vehicle (V2V) communication, a vehicle to Infrastructure (V2I) communication and a vehicle to pedestrian (V2P) communication in a vehicle to everything communication.

Here, the above-mentioned user equipment may be considered as the terminal device of the following embodiments.

In some embodiments, the above-mentioned wireless communication system may further include a network management device 130.

Several base stations 120 are respectively connected with the network management device 130. The network management device 130 may be a core network device in the wireless communication system. For example, the network management device 130 may be a mobility management entity (MME) in an evolved packet core (EPC). Alternatively, the network management device may also be other core network devices, such as a serving gateway (SGW), a public data network gateway (PGW), a policy and charging rules function (PCRF) or a home subscriber server (HSS). The embodiments of the present disclosure do not limit the implementation form of the network management device 130.

In order to facilitate the understanding of those skilled in the art, the embodiments of the present disclosure list a plurality of implementations to clearly explain the technical solutions of the embodiments of the present disclosure. Those skilled in the art may understand that the implementations provided by the embodiments of the present disclosure may be performed alone, or may be performed together after being combined with the methods of other embodiments in the embodiments of the present disclosure, or may also be executed alone or in combination with some methods of other related technologies, which is not limited by the embodiments of the present disclosure.

In order to better understand the technical solution described in any embodiment of the present disclosure, firstly, the application scenarios in related art are described in the following.

In one embodiment, for the RRC connection state, a power-saving signal, namely a wakeup signal (WUS) or downlink control information for power saving (DCP, that is, DCI for power saving) is introduced. The WUS signal is a low-power detection signal. If the terminal detects the WUS signal, it means that the terminal needs to monitor a physical downlink control channel (PDCCH), but if the WUS does not be detected, the monitoring of the PDCCH is skipped.

In one embodiment, for the RRC idle state, a power-saving signal (e.g., PEI) is usually configured before a paging occasion (PO). If the terminal does not detect the power-saving signal, it needs to skip a paging DCI, otherwise, it needs to monitor the paging DCI.

In one embodiment, the RRC connection state is further enhanced, and a mechanism of PDCCH skipping is introduced, that is, the PDCCH skipping may be carried in DCI to inform the terminal to skip the monitoring for a period of time or switch a search space group.

It should be noted that no matter what kind of power-saving signal, a modem of the terminal is required to detect the power-saving signal at this time.

In one embodiment, a separate transceiver (i.e., a low power wake-up receiver) is introduced to receive the power-saving signal, and the modem part or main radio part of the terminal can only be woken up after the separate transceiver is woken up, otherwise, the modem part will always be in a sleep state.

In one embodiment, in order to meet the requirements of single-user peak rate and system capacity improvement, the characteristics of carrier aggregation (CA) are introduced. CA may be divided into continuous carrier aggregation and discontinuous carrier aggregation. For continuous carrier aggregation, the terminal only needs one transceiver. For different bandwidths of discontinuous carrier aggregation, different radio frequency (RF) chains are needed. Therefore, it is very likely that a primary cell (Pcell) and a secondary cell (Scell) use different RF chains. Different discontinuous reception (DRX) groups (e.g., a first DRX group and a second DRX group) may be set for the Pcell and the Scell. The two DRX groups are started together at the same onduration starting point. Moreover, the wakeup signal is not used in a dual DRX scenario.

As shown in FIG. 2, a wireless communication method is provided in this embodiment. The method is performed by a terminal, and the method includes the following steps.

In step 21, in response to a first type transceiver receiving a wakeup signal, a second type transceiver is woken up through the first type transceiver.

The second type transceiver includes at least one of the following: a first transceiver, configured to perform data monitoring based on a discontinuous reception (DRX) parameter of a first DRX group; and a second transceiver, configured to perform data monitoring based on a DRX parameter of a second DRX group.

Here, the terminal involved in the present disclosure may be, but is not limited to, a mobile phone, a wearable device, a vehicle-mounted terminal, a road side unit (RSU), a smart home terminal, an industrial sensing device and/or a medical device. In some embodiments, the terminal may be a redcap terminal or a new air interface NR terminal of a predetermined version (e.g., the NR terminal of R17).

The access network device involved in the present disclosure may be a base station, for example, a base station of the third generation mobile communication (3G) network, a base station of the fourth generation mobile communication (4G) network, a base station of the fifth generation mobile communication (5G) network or other evolved base stations.

The first type transceiver may be a separate transceiver (low power wake-up receiver).

The second type transceiver may be a main radio receiver (main radio). The power consumption of the first type transceiver is less than that of the second type transceiver.

The wakeup signal may be a low power wakeup signal (low power WUS), which is used to wake up the second type transceiver. It should be noted that the wakeup signal may wake up a single or multiple second type transceivers at the same time. For example, an information field corresponding to the wakeup signal contains one bit, which may wake up one second type transceiver or two second type transceivers at the same time. Alternatively, the information field corresponding to the wakeup signal contains multiple bits, which may wake up two second type transceivers respectively.

In one embodiment, in response to the first type transceiver receiving the wakeup signal, the second type transceiver is woken up through the first type transceiver. The second type transceiver includes at least one of the following: a first transceiver for performing data monitoring based on a discontinuous reception (DRX) parameter of a first DRX group configured for a primary cell; or a second transceiver for performing data monitoring based on a DRX parameter of a second DRX group configured for a secondary cell.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. In response to the first transceiver receiving a predetermined instruction sent by an access network device, the second transceiver is woken up by the first transceiver. Here, the predetermined instruction sent by the access network device may be received through a RRC signaling, a media access control (MAC) control element (CE) or downlink control information (DCI).

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the second transceiver is woken up by the first type transceiver. In response to the second transceiver receiving a predetermined instruction sent by an access network device, the first transceiver is woken up by the second transceiver. Here, the predetermined instruction sent by the access network device may be received through a RRC signaling, a media access control (MAC) control element (CE) or downlink control information (DCI).

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. In response to the first transceiver being woken up, monitoring of a power-saving downlink control signal (DCP) or a physical downlink control channel is started according to a C-DRX parameter of the first DRX group configured by the network.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. If the wakeup signal needs to trigger starting an inactive timer (i.e., an IAT timer), an inactive timer corresponding to the first DRX group of the first transceiver is started.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. In response to the first transceiver receiving a predetermined instruction sent by an access network device, the second transceiver is woken up by the first transceiver. In response to the second transceiver being woken up, monitoring of a power-saving downlink control signal (DCP) or a physical downlink control channel is started according to a C-DRX parameter of the second DRX group configured by the network.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. In response to the first transceiver receiving a predetermined instruction sent by an access network device, the second transceiver is woken up by the first transceiver. If the wakeup signal needs to trigger starting of an inactive timer (i.e., an IAT timer), an inactive timer corresponding to the second DRX group of the second transceiver is started.

It should be noted that for a transceiver not configured with a DRX, the transceiver directly performs time-frequency domain synchronization and monitoring after being woken up, without monitoring according to the C-DRX parameter.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver and the second transceiver are woken up by the first type transceiver.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver and the second transceiver are woken up by the first type transceiver. In response to the first transceiver being woken up, monitoring of a power-saving downlink control signal (DCP) or a physical downlink control channel is started according to a C-DRX parameter of the first DRX group configured by the network. In response to the second transceiver being woken up, the monitoring of the power-saving downlink control signal (DCP) or the physical downlink control channel is started according to a C-DRX parameter of the second DRX group configured by the network.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver and the second transceiver are woken up by the first type transceiver. If the wakeup signal needs to trigger starting of an inactive timer (i.e., an IAT timer), an inactive timer corresponding to the first DRX group of the first transceiver and/or an inactive timer corresponding to the second DRX group of the second transceiver is started.

In one embodiment, the terminal is provided with two first type transceivers and two second type transceivers. The first type transceiver includes a third transceiver and a fourth transceiver. The second type transceiver includes a first transceiver and a second transceiver. The first transceiver is used for performing data monitoring based on a discontinuous reception (DRX) parameter of a first DRX group. A second transceiver is used for performing data monitoring based on a DRX parameter of a second DRX group. A frequency range of the first DRX group is a first frequency range FR1; and/or a frequency range of the second DRX group is a second frequency range FR2. The first transceiver is woken up through the third transceiver in response to the third transceiver receiving a wakeup signal; and the second transceiver is woken up through the fourth transceiver in response to the fourth transceiver receiving a wakeup signal. It should be noted that the wakeup signal received by the third transceiver and the wakeup signal received by the fourth transceiver may be the same or different, which is not limited herein.

In one embodiment, the terminal is provided with two first type transceivers and two second type transceivers. The first type transceiver includes a third transceiver and a fourth transceiver. The second type transceiver includes a first transceiver and a second transceiver. The first transceiver is used for performing data monitoring based on a discontinuous reception (DRX) parameter of a first DRX group. A second transceiver is used for performing data monitoring based on a DRX parameter of a second DRX group. A frequency range of the first DRX group is a first frequency range FR1; and/or a frequency range of the second DRX group is a second frequency range FR2. The first transceiver is woken up through the third transceiver through the third transceiver in response to the third transceiver receiving a wakeup signal; and/or the second transceiver is woken up through the fourth transceiver in response to the fourth transceiver receiving a wakeup signal. In response to the first transceiver being woken up, monitoring of a power-saving downlink control signal (DCP) or a physical downlink control channel is started according to a C-DRX parameter of the first DRX group configured by the network. In response to the second transceiver being woken up, the monitoring of the power-saving downlink control signal (DCP) or the physical downlink control channel is started according to a C-DRX parameter of the second DRX group configured by the network.

In one embodiment, if the wakeup signal needs to trigger starting of an inactive timer (i.e., an IAT timer), an inactive timer corresponding to the first DRX group of the first transceiver and/or an inactive timer corresponding to the second DRX group of the second transceiver is started. It should be noted that the wakeup signal received by the third transceiver and the wakeup signal received by the fourth transceiver may be the same or different, which is not limited herein.

In one implementation, capability information sent by an access network device is received. The capability information is used to indicate that the first type transceiver is supported to wake up the first transceiver and/or the second transceiver in the second type transceiver after the first type transceiver receives the wakeup signal. In response to the indication of the capability information, after the first type transceiver receives the wakeup signal, the first type transceiver is supported to wake up the first transceiver and/or the second transceiver in the second type transceiver, and after the first type transceiver receives the wakeup signal, the second type transceiver is woken up through the first type transceiver. The second type transceiver includes at least one of the following: a first transceiver, configured to perform data monitoring based on a discontinuous reception (DRX) parameter of a first DRX group; and a second transceiver, configured to perform data monitoring based on a DRX parameter of a second DRX group.

It should be noted that the terminal may have the capability to wake up the first transceiver and/or the second transceiver in the second type transceiver through the first type transceiver after the first type transceiver receives the wakeup signal. However, a function of whether the terminal wakes up the first transceiver and/or the second transceiver in the second type transceiver through the first type transceiver after the first type transceiver receives the wakeup signal needs to be based on an indication from the network side. For example, when the received capability information sent by the access network device indicates that the first type transceiver is supported to wake up the first transceiver and/or the second transceiver in the second type transceiver after receiving the wakeup signal, the terminal will turn on the function of waking up the first transceiver and/or the second transceiver in the second type transceiver through the first type transceiver. Alternatively, when the received capability information sent by the access network device indicates that the first type transceiver is not supported to wake up the first transceiver and/or the second transceiver in the second type transceiver after receiving the wakeup signal, the terminal will not turn on the function of waking up the first transceiver and/or the second transceiver in the second type transceiver through the first type transceiver.

In the embodiments of the present disclosure, in response to a first type transceiver receiving a wakeup signal, a second type transceiver is woken up through the first type transceiver; where, the second type transceiver includes at least one of the following: a first transceiver configured to perform data monitoring based on a DRX parameter of a first DRX group; or a second transceiver configured to perform data monitoring based on a DRX parameter of a second DRX group. Here, the first type transceiver can wake up the first transceiver and/or the second transceiver, and the data monitoring can be performed based on the DRX parameter of the first discontinuous reception DRX group and/or the DRX parameter of the second DRX group, respectively. Compared with the way that data monitoring cannot be performed based on the DRX parameters of different DRX groups, the embodiments of the present disclosure can adapt to different data monitoring scenarios and thus have a strong adaptability, and are beneficial for saving on power and improving an endurance capacity of the terminal.

It should be noted that those skilled in the art can understand that the methods provided by the embodiments of the present disclosure may be executed alone or together with some methods in the embodiments of the present disclosure or some methods in related art.

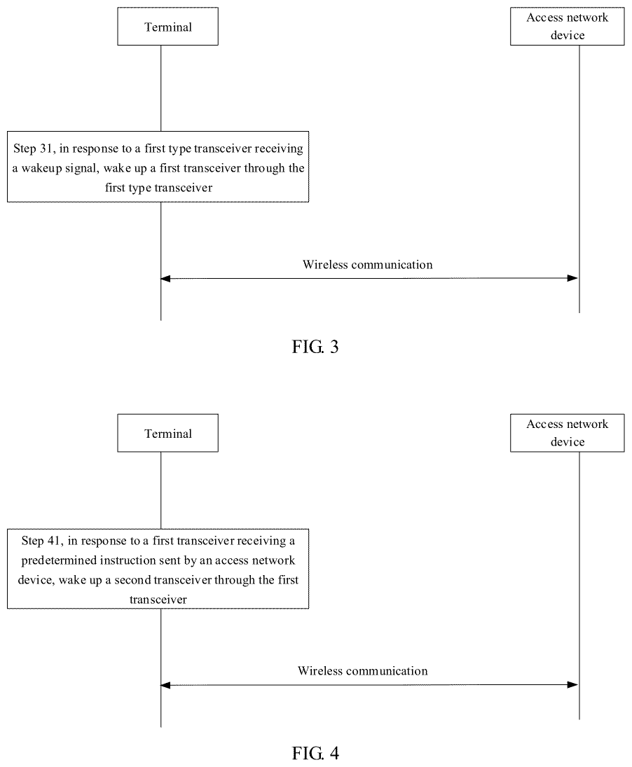

As shown in FIG. 3, a wireless communication method is provided in this embodiment. The method is performed by a terminal, and the method includes the following steps.

In step 31, in response to a first type transceiver receiving a wakeup signal, a first transceiver is woken up through the first type transceiver.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver.

It should be noted that those skilled in the art can understand that the methods provided by the embodiments of the present disclosure may be executed alone or together with some methods in the embodiments of the present disclosure or some methods in related art.

As shown in FIG. 4, a wireless communication method is provided in this embodiment. The method is performed by a terminal, and the method includes the following steps.

In step 41, in response to a first transceiver receiving a predetermined instruction sent by an access network device, a second transceiver is woken up through the first transceiver.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver is woken up by the first type transceiver. In response to the first transceiver receiving a predetermined instruction sent by an access network device, the second transceiver is woken up by the first transceiver. Here, the predetermined instruction sent by the access network device may be received through a RRC signaling, a media access control (MAC) control element (CE) or downlink control information (DCI).

It should be noted that those skilled in the art can understand that the methods provided by the embodiments of the present disclosure may be executed alone or together with some methods in the embodiments of the present disclosure or some methods in related art.

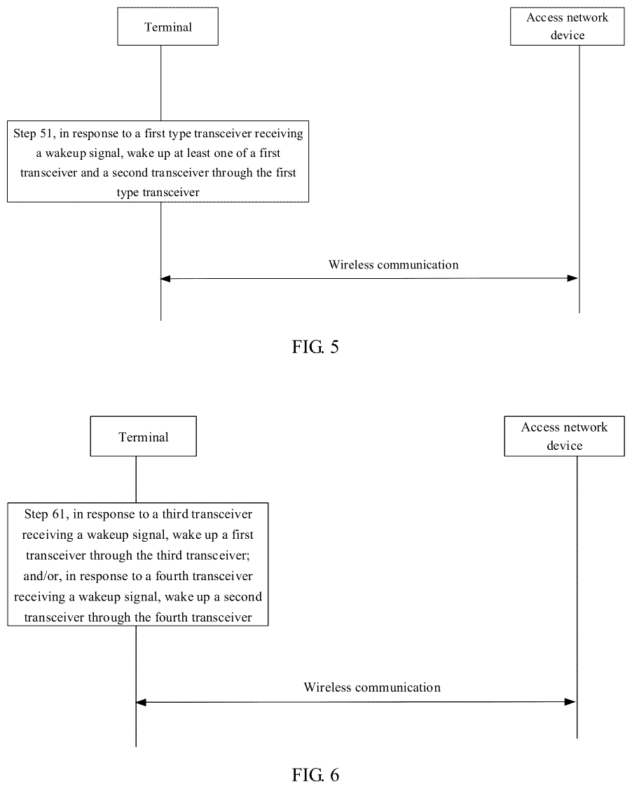

As shown in FIG. 5, a wireless communication method is provided in this embodiment. The method is performed by a terminal, and the method includes the following steps.

In step 51, in response to a first type transceiver receiving a wakeup signal, at least one of a first transceiver and a second transceiver is woken up through the first type transceiver.

In one embodiment, the terminal is provided with one first type transceiver and two second type transceivers. The second type transceiver includes a first transceiver and a second transceiver. The first transceiver is used for performing data monitoring based on a discontinuous reception (DRX) parameter of a first DRX group. The second transceiver is used for performing data monitoring based on a DRX parameter of a second DRX group. In response to the first type transceiver receiving the wakeup signal, the first transceiver and the second transceiver are woken up by the first type transceiver.

It should be noted that those skilled in the art can understand that the methods provided by the embodiments of the present disclosure may be executed alone or together with some methods in the embodiments of the present disclosure or some methods in related art.

As shown in FIG. 6, a wireless communication method is provided in this embodiment. The method is performed by a terminal, and the method includes the following steps.

In step 61, in response to a third transceiver receiving a wakeup signal, a first transceiver is woken up through the third transceiver; and/or in response to a fourth transceiver receiving a wakeup signal, a second transceiver is woken up through the fourth transceiver.

In one embodiment, the terminal is provided with two first type transceivers and two second type transceivers. The first type transceiver includes a third transceiver and a fourth transceiver. The second type transceiver includes a first transceiver and a second transceiver. The first transceiver is used for performing data monitoring based on a discontinuous reception (DRX) parameter of a first DRX group. A second transceiver is used for performing data monitoring based on a DRX parameter of a second DRX group. A frequency range of the first DRX group is a first frequency range FR1; and/or a frequency range of the second DRX group is a second frequency range FR2. The first transceiver is woken up through the third transceiver in response to the third transceiver receiving a wakeup signal; and/or the second transceiver is woken up through the fourth transceiver in response to the fourth transceiver receiving a wakeup signal. It should be noted that the wakeup signal received by the third transceiver and the wakeup signal received by the fourth transceiver may be the same or different, which is not limited herein.

It should be noted that those skilled in the art can understand that the methods provided by the embodiments of the present disclosure may be executed alone or together with some methods in the embodiments of the present disclosure or some methods in related art.

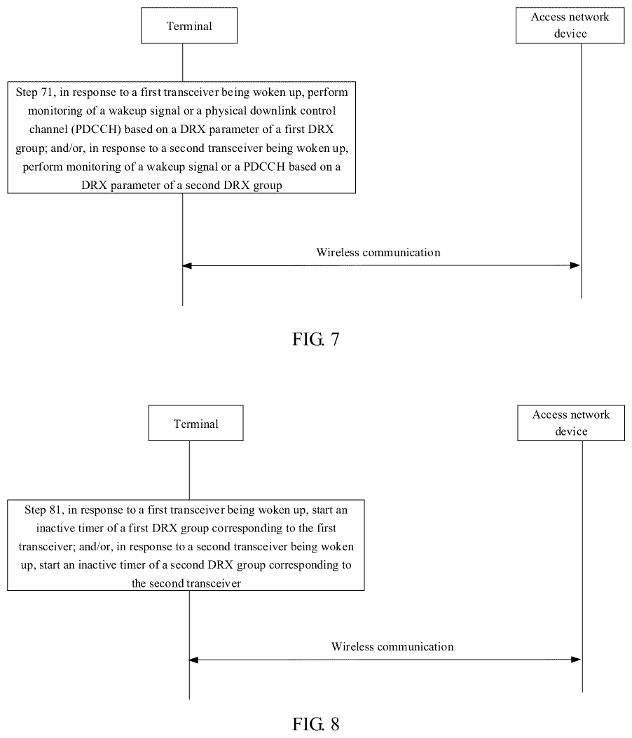

As shown in FIG. 7, a wireless communication method is provided in this embodiment. The method is performed by a terminal, and the method includes the following steps.

In step 71, in response to a first transceiver being woken up, monitoring of a wakeup signal or a physical downlink control channel (PDCCH) is performed based on a DRX parameter of a first DRX group;
and/or,
in response to a second transceiver being woken up, monitoring of a wakeup signal or a PDCCH is performed based on a DRX parameter of a second DRX group.

For the specific description in the present disclosure, please specifically refer to the description for step 21 in FIG. 2, which is not repeated herein.

It should be noted that those skilled in the art can understand that the methods provided by the embodiments of the present disclosure may be executed alone or together with some methods in the embodiments of the present disclosure or some methods in related art.

As shown in FIG. 8, a wireless communication method is provided in this embodiment. The method is performed by a terminal, and the method includes the following steps.

In step 81, in response to a first transceiver being woken up, an inactive timer of a first DRX group corresponding to the first transceiver is started;
and/or,
in response to a second transceiver being woken up, an inactive timer of a second DRX group corresponding to the second transceiver is started.

In one embodiment, in response to the first transceiver being woken up, if the wakeup signal needs to trigger starting of an inactive timer (i.e., an IAT timer), an inactive timer corresponding to the first DRX group of the first transceiver is started.

In one embodiment, in response to the second transceiver being woken up, if the wakeup signal needs to trigger starting of an inactive timer (i.e., an IAT timer), an inactive timer corresponding to the second DRX group of the second transceiver is started.

It should be noted that those skilled in the art can understand that the methods provided by the embodiments of the present disclosure may be executed alone or together with some methods in the embodiments of the present disclosure or some methods in related art.

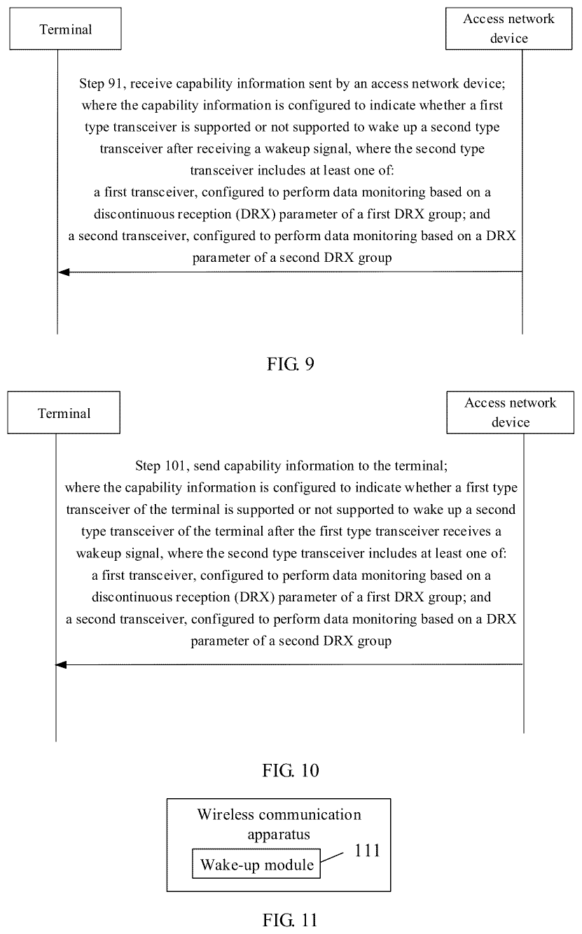

As shown in FIG. 9, a wireless communication method is provided in this embodiment. The method is performed by a terminal, and the method includes the following steps.

In step 91, capability information sent by an access network device is received.

The capability information is used for indicating whether a first type transceiver is supported or not supported to wake up a second type transceiver after receiving a wakeup signal. The second type transceiver includes at least one of the following:
a first transceiver, configured to perform data monitoring based on a discontinuous reception (DRX) parameter of a first DRX group; and
a second transceiver, configured to perform data monitoring based on a DRX parameter of a second DRX group.

In one implementation, capability information sent by an access network device is received. The capability information is used to indicate that the first type transceiver is supported to wake up the first transceiver and/or the second transceiver in the second type transceiver after the first type transceiver receives the wakeup signal. In response to the indication of the capability information, after the first type transceiver receives the wakeup signal, the first type transceiver is supported to wake up the first transceiver and/or the second transceiver in the second type transceiver, and after the first type transceiver receives the wakeup signal, the second type transceiver is woken up through the first type transceiver. The second type transceiver includes at least one of the following: a first transceiver, configured to perform data monitoring based on a discontinuous reception (DRX) parameter of a first DRX group; and a second transceiver, configured to perform data monitoring based on a DRX parameter of a second DRX group.

In one implementation, capability information sent by an access network device is received. The capability information is used to indicate that the first type transceiver is supported to wake up the first transceiver in the second type transceiver after the first type transceiver receives the wakeup signal. In response to the indication of the capability information, after the first type transceiver receives the wakeup signal, the first type transceiver is supported to wake up the first transceiver in the second type transceiver, and after the first type transceiver receives the wakeup signal, the first transceiver is woken up through the first type transceiver. The first transceiver is configured to perform data monitoring based on a discontinuous reception (DRX) parameter of a first DRX group.

In one implementation, capability information sent by an access network device is received. The capability information is used to indicate that the first type transceiver is supported to wake up the second transceiver in the second type transceiver after the first type transceiver receives the wakeup signal. In response to the indication of the capability information, after the first type transceiver receives the wakeup signal, the first type transceiver is supported to wake up the second transceiver in the second type transceiver, and after the first type transceiver receives the wakeup signal, the second transceiver is woken up through the first type transceiver. The second transceiver is configured to perform data monitoring based on a discontinuous reception (DRX) parameter of a second DRX group.

In one implementation, capability information sent by an access network device is received. The capability information is used to indicate that the first type transceiver is supported to wake up the first transceiver and the second transceiver in the second type transceiver after the first type transceiver receives the wakeup signal. In response to the indication of the capability information, after the first type transceiver receives the wakeup signal, the first type transceiver is supported to wake up the first transceiver and the second transceiver in the second type transceiver, and after the first type transceiver receives the wakeup signal, the second type transceiver is woken up through the first type transceiver. The second type transceiver includes: a first transceiver, configured to perform data monitoring based on a discontinuous reception (DRX) parameter of a first DRX group; and a second transceiver, configured to perform data monitoring based on a DRX parameter of a second DRX group.

It should be noted that those skilled in the art can understand that the methods provided by the embodiments of the present disclosure may be executed alone or together with some methods in the embodiments of the present disclosure or some methods in related art.

As shown in FIG. 10, a wireless communication method is provided in this embodiment. The method is performed by an access network device, and the method includes the following steps.

In step 101, capability information is sent to a terminal.

The capability information is used to indicate whether a first type transceiver of the terminal is supported or not supported to wake up a second type transceiver of the terminal after the first type transceiver of the terminal receives a wakeup signal. The second type transceiver includes at least one of the following:
a first transceiver, configured to perform data monitoring based on a discontinuous reception (DRX) parameter of a first DRX group; and
a second transceiver, configured to perform data monitoring based on a DRX parameter of a second DRX group.

In one implementation, capability information is sent to a terminal. The capability information is used to indicate that the first type transceiver is supported to wake up the first transceiver and/or the second transceiver in the second type transceiver after the first type transceiver receives the wakeup signal. In response to the indication of the capability information, after the first type transceiver receives the wakeup signal, the first type transceiver is supported to wake up the first transceiver and/or the second transceiver in the second type transceiver, and after the first type transceiver of the terminal receives the wakeup signal, the terminal wakes up the second type transceiver through the first type transceiver. The second type transceiver includes at least one of the following: a first transceiver, configured to perform data monitoring based on a discontinuous reception (DRX) parameter of a first DRX group; and a second transceiver, configured to perform data monitoring based on a DRX parameter of a second DRX group.

In one implementation, capability information is sent to a terminal. The capability information is used to indicate that the first type transceiver is supported to wake up the first transceiver in the second type transceiver after the first type transceiver receives the wakeup signal. In response to the indication of the capability information, after the first type transceiver receives the wakeup signal, the first type transceiver is supported to wake up the first transceiver in the second type transceiver, and after the first type transceiver of the terminal receives the wakeup signal, the terminal wakes up the first transceiver through the first type transceiver. The first transceiver is configured to perform data monitoring based on a discontinuous reception (DRX) parameter of a first DRX group.

In one implementation, capability information is sent to a terminal. The capability information is used to indicate that the first type transceiver is supported to wake up the second transceiver in the second type transceiver after the first type transceiver receives the wakeup signal. In response to the indication of the capability information, after the first type transceiver receives the wakeup signal, the first type transceiver is supported to wake up the second transceiver in the second type transceiver, and after the first type transceiver of the terminal receives the wakeup signal, the terminal wakes up the second transceiver through the first type transceiver. The second transceiver is configured to perform data monitoring based on a discontinuous reception (DRX) parameter of a second DRX group.

In one implementation, capability information is sent to a terminal. The capability information is used to indicate that the first type transceiver is supported to wake up the first transceiver and the second transceiver in the second type transceiver after the first type transceiver receives the wakeup signal. In response to the indication of the capability information, after the first type transceiver receives the wakeup signal, the first type transceiver is supported to wake up the first transceiver and the second transceiver in the second type transceiver, and after the first type transceiver of the terminal receives the wakeup signal, the terminal wakes up the second type transceiver through the first type transceiver. The second type transceiver includes: a first transceiver, configured to perform data monitoring based on a discontinuous reception (DRX) parameter of a first DRX group; and a second transceiver, configured to perform data monitoring based on a DRX parameter of a second DRX group.

It should be noted that the terminal may have the capability to wake up the first transceiver and/or the second transceiver in the second type transceiver through the first type transceiver after the first type transceiver receives the wakeup signal. However, a function of whether the terminal wakes up the first transceiver and/or the second transceiver in the second type transceiver through the first type transceiver after the first type transceiver receives the wakeup signal needs to be based on an indication from the network side. For example, when the received capability information sent by the access network device indicates that the first type transceiver is supported to wake up the first transceiver and/or the second transceiver in the second type transceiver after receiving the wakeup signal, the terminal will turn on the function of waking up the first transceiver and/or the second transceiver in the second type transceiver through the first type transceiver. Alternatively, when the received capability information sent by the access network device indicates that the first type transceiver is not supported to wake up the first transceiver and/or the second transceiver in the second type transceiver after receiving the wakeup signal, the terminal will not turn on the function of waking up the first transceiver and/or the second transceiver in the second type transceiver through the first type transceiver.

It should be noted that those skilled in the art can understand that the methods provided by the embodiments of the present disclosure may be executed alone or together with some methods in the embodiments of the present disclosure or some methods in related art.

As shown in FIG. 11, a wireless communication apparatus is provided in this embodiment. The apparatus includes:
a wake-up module 111, configured to wake up a second type transceiver through a first type transceiver in response to the first type transceiver receiving a wakeup signal.

The second type transceiver includes at least one of: a first transceiver, configured to perform data monitoring based on a discontinuous reception (DRX) parameter of a first DRX group configured for a primary cell; and a second transceiver, configured to perform data monitoring based on a DRX parameter of a second DRX group configured for a secondary cell.

It should be noted that those skilled in the art can understand that the methods provided by the embodiments of the present disclosure may be executed alone or together with some methods in the embodiments of the present disclosure or some methods in related art.

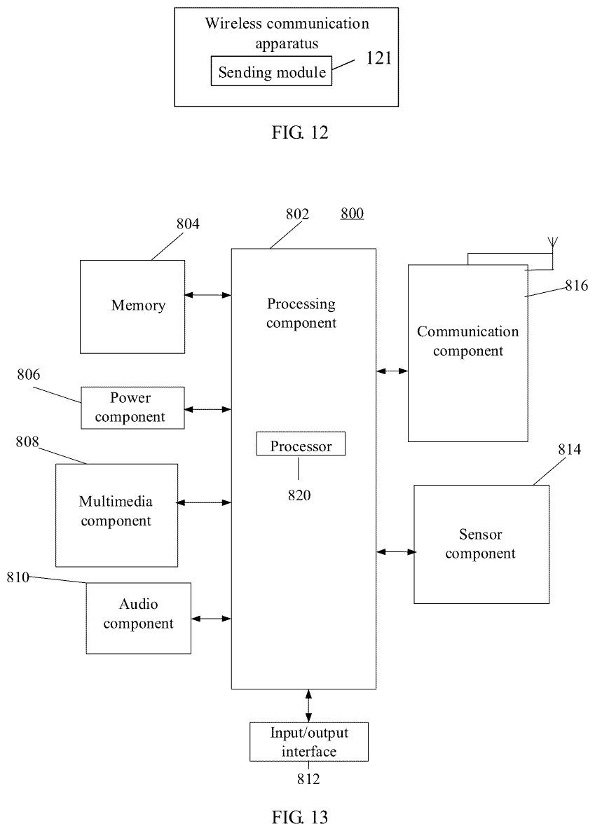

As shown in FIG. 12, a wireless communication apparatus is provided in this embodiment. The apparatus includes:
a sending module 121, configured to send capability information to a terminal.

The capability information is used for indicating whether a first type transceiver is supported or not supported to wake up a second type transceiver of the terminal after the first type transceiver of the terminal receives a wakeup signal. The second type transceiver includes at least one of:
a first transceiver, configured to perform data monitoring based on a discontinuous reception (DRX) parameter of a first DRX group; and
a second transceiver, configured to perform data monitoring based on a DRX parameter of a second DRX group.

It should be noted that those skilled in the art can understand that the methods provided by the embodiments of the present disclosure may be executed alone or together with some methods in the embodiments of the present disclosure or some methods in related art.

A communication device is provided in embodiments of the present disclosure, and includes:
a processor;
a memory, configured to store an executable instruction of the processor;
where the processor is configured to implement the method applied to any embodiment of the present disclosure when executing the executable instruction.

The processor may include various types of storage media, which are non-temporary computer storage media, and can continue to memorize and store the information on the communication device after power failure.

The processor may be connected with the memory through a bus or the like for reading an executable program stored on the memory.

The embodiments of the present disclosure also provide a computer storage medium, where the computer storage medium stores a computer executable program, and the executable program, when executed by a processor, realizes the method of any embodiment of the present disclosure.

With respect to the apparatuses in the above embodiments, the specific manners for performing operations for individual modules therein have been described in detail in the embodiments regarding the methods, which will not be elaborated herein.

As shown in FIG. 13, one embodiment of the present disclosure provides a structure of a terminal.

Referring to a terminal 800 shown in FIG. 13, this embodiment provides the terminal 800, which may be a mobile phone, a computer, a digital broadcast terminal, a messaging device, a gaming console, a tablet, a medical device, exercise equipment, a personal digital assistant, and the like.

Referring to FIG. 13, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the terminal 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the device 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the terminal 800, for performing the above-described methods. For example, the non-transitory computer-readable storage medium may be a ROM, a RAM, a CD-ROM, a magnetic tape, a floppy disc, an optical data storage device, and the like.

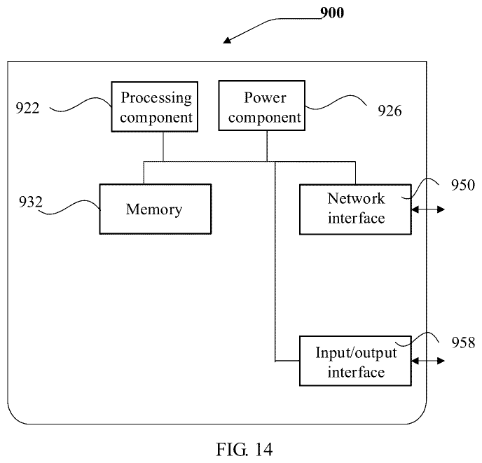

As shown in FIG. 14, an embodiment of the present disclosure illustrates a structure of a base station. For example, the base station 900 may be provided as a network side device. Referring to FIG. 14, the base station 900 includes a processing component 922, which further includes one or more processors, and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions to perform any of the aforementioned methods applied to the base station.

The base station 900 may further include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as a Windows Server™, a Mac OS X™, a Unix™, a Linux™, a Free BSD™ or the like.

Other embodiments of the present disclosure will be apparent to those skilled in the art from consideration of the specification and practice of the contents disclosed here. The present disclosure is intended to cover any variations, uses, or adaptations of the present disclosure, which follows the general principles thereof and includes the common knowledge or habitual technical means in this technical field that is not disclosed in the present disclosure. The specification and embodiments are considered as exemplary only, with a true scope and spirit of the present disclosure being indicated by the appending claims.

It will be appreciated that the present disclosure is not limited to the exact construction that has been described above and illustrated in the accompanying drawings, and various modifications and changes can be made without departing from the scope thereof. The scope of the present disclosure is only limited by the appended claims.

1. A wireless communication method, wherein the method is performed by a terminal, and the method comprises:
waking up a second type transceiver through a first type transceiver in response to the first type transceiver receiving a wakeup signal;
wherein the second type transceiver comprises at least one of:
a first transceiver, configured to perform data monitoring based on a discontinuous reception (DRX) parameter of a first DRX group; or
a second transceiver, configured to perform data monitoring based on a DRX parameter of a second DRX group.

2. The method according to claim 1, wherein waking up the second type transceiver through the first type transceiver in response to the first type transceiver receiving the wakeup signal comprises:
waking up the first transceiver through the first type transceiver in response to the first type transceiver receiving the wakeup signal.

3. The method according to claim 2, wherein the method further comprises:
waking up the second transceiver through the first transceiver in response to the first transceiver receiving a predetermined instruction sent by an access network device.

4. The method according to claim 1, wherein waking up the second type transceiver through the first type transceiver in response to the first type transceiver receiving the wakeup signal comprises:
waking up at least one of the first transceiver or the second transceiver through the first type transceiver in response to the first type transceiver receiving the wakeup signal.

5. The method according to claim 1, wherein the first type transceiver comprises a third transceiver and a fourth transceiver; and waking up the second type transceiver through the first type transceiver in response to the first type transceiver receiving the wakeup signal comprises at least one of:
waking up the first transceiver through the third transceiver in response to the third transceiver receiving the wakeup signal;
or,
waking up the second transceiver through the fourth transceiver in response to the fourth transceiver receiving the wakeup signal.

6. The method according to claim 1, wherein a frequency range of the first DRX group is a first frequency range FR1; or a frequency range of the second DRX group is a second frequency range; or the frequency range of the first DRX group is the first frequency range FR1 and the frequency range of the second DRX group is the second frequency range.

7. The method according to claim 1, wherein the method further comprises at least one of:
in response to the first transceiver being woken up, performing monitoring of the wakeup signal or a physical downlink control channel (PDCCH) based on the DRX parameter of the first DRX group;
or,
in response to the second transceiver being woken up, performing monitoring of the wakeup signal or the PDCCH based on the DRX parameter of the second DRX group.

8. The method according to claim 1, wherein the method further comprises at least one of:
in response to the first transceiver being woken up, starting an inactive timer of the first DRX group corresponding to the first transceiver;
or,
in response to the second transceiver being woken up, starting an inactive timer of the second DRX group corresponding to the second transceiver.

9. The method according to claim 1, wherein the method further comprises:
receiving capability information sent by an access network device;
wherein, the capability information is configured to indicate: supporting the first type transceiver to wake up at least one of the first transceiver or the second transceiver in the second type transceiver after the first type transceiver receives the wakeup signal.

10. A wireless communication method, wherein the method is performed by an access network device, and the method comprises:
sending capability information to a terminal;
wherein, the capability information is configured to indicate whether a first type transceiver of the terminal is supported or not supported to wake up a second type transceiver of the terminal after the first type transceiver receives a wakeup signal;
and wherein the second type transceiver comprises at least one of:
a first transceiver, configured to perform data monitoring based on a discontinuous reception (DRX) parameter of a first DRX group; or
a second transceiver, configured to perform data monitoring based on a DRX parameter of a second DRX group.

11. A wireless communication apparatus, wherein the apparatus comprises:
a processor; and
a memory storing instructions executable by the processor;
wherein in the processor is configured to:
wake up a second type transceiver through a first type transceiver in response to the first type transceiver receiving a wakeup signal;
wherein the second type transceiver comprises at least one of:
a first transceiver, configured to perform data monitoring based on a discontinuous reception (DRX) parameter of a first DRX group; or
a second transceiver, configured to perform data monitoring based on a DRX parameter of a second DRX group.

12. A wireless communication apparatus, wherein the apparatus comprises:
a processor; and
a memory storing instructions executable by the processor;
wherein in the processor is configured to perform the wireless communication method according to claim 10.

13.-14. (canceled)

15. The apparatus according to claim 11, wherein the processor is further configured to:
wake up the first transceiver through the first type transceiver in response to the first type transceiver receiving the wakeup signal.

16. The apparatus according to claim 15, wherein the processor is further configured to:
wake up the second transceiver through the first transceiver in response to the first transceiver receiving a predetermined instruction sent by an access network device.

17. The apparatus according to claim 11, wherein the processor is further configured to:
wake up at least one of the first transceiver or the second transceiver through the first type transceiver in response to the first type transceiver receiving the wakeup signal.

18. The apparatus according to claim 11, wherein the first type transceiver comprises a third transceiver and a fourth transceiver; and the processor is further configured to perform at least one of:
waking up the first transceiver through the third transceiver in response to the third transceiver receiving the wakeup signal;
or,
waking up the second transceiver through the fourth transceiver in response to the fourth transceiver receiving the wakeup signal.

19. The apparatus according to claim 11, wherein a frequency range of the first DRX group is a first frequency range FR1; or a frequency range of the second DRX group is a second frequency range; or the frequency range of the first DRX group is the first frequency range FR1 and the frequency range of the second DRX group is the second frequency range.

20. The apparatus according to claim 11, wherein the processor is further configured to perform at least one of:
in response to the first transceiver being woken up, performing monitoring of the wakeup signal or a physical downlink control channel (PDCCH) based on the DRX parameter of the first DRX group;
or,
in response to the second transceiver being woken up, performing monitoring of the wakeup signal or the PDCCH based on the DRX parameter of the second DRX group.

21. The apparatus according to claim 11, wherein the processor is further configured to perform at least one of:
in response to the first transceiver being woken up, starting an inactive timer of the first DRX group corresponding to the first transceiver;
or,
in response to the second transceiver being woken up, starting an inactive timer of the second DRX group corresponding to the second transceiver.

22. The apparatus according to claim 11, wherein the processor is further configured to:
receive capability information sent by an access network device;
wherein, the capability information is configured to indicate: supporting the first type transceiver to wake up at least one of the first transceiver or the second transceiver in the second type transceiver after the first type transceiver receives the wakeup signal.
